(19) United States
(12) Patent Application Publication
(10) Pub. No.: US 2026/0368458 A1
(43) Pub. Date: Nov. 19, 2026

(54) AUDIO TRANSLATION FOR DEVICE-TO-DEVICE COMMUNICATIONS

(71) Applicant: Apple Inc., Cupertino, CA (US)

(72) Inventors: Jingyao ZHANG, Sunnyvale, CA (US); Adam Y. SYED, San Francisco, CA (US); Akshatha NAGESH, Sunnyvale, CA (US); Benjamin H. ROOS, San Jose, CA (US); Daniel B. POLLACK, Cupertino, CA (US); Gregory KELLUM, Irvine, CA (US); Imran AHMED, Fremont, CA (US); Joris B. KLUIVERS, Campbell, CA (US); Justin R. ETZINE, San Jose, CA (US); Karthick SANTHANAM, Campbell, CA (US); Nicolas WAGNER, San Francisco, CA (US); Shao Hua KAO, Sunnyvale, CA (US); Sri Ranjan SRIKANTAM, Campbell, CA (US); Eunice Y. LEE, San Francisco, CA (US); Grant R. PAUL, San Francisco, CA (US); Lauren E. TAPPANA, San Francisco, CA (US); Christopher M. GARRIDO, Santa Clara, CA (US); Alan BITHELL, Cupertino, CA (US); Luyang LI, Newark, CA (US)

(21) Appl. No.: 19/679,294

(22) Filed: May 15, 2026

Related U.S. Application Data
(60) Provisional application No. 63/808,617, filed on May 19, 2025.
(60) Provisional application No. 63/819,901, filed on Jun. 8, 2025.

(51) Int. Cl. G06F 40/58; G06F 3/16

(52) U.S. Cl. CPC G06F 40/58; G06F 3/165

(57) ABSTRACT

Aspects of the subject technology provide for translation of audio content during a media session, such as an audio or video call between two or more devices. The translation can be generated by a local device at which the audio input is received, and transmitted to a remote device at which the translation is provided at the remote device. The translation can be generated by the remote device and provided back to the local device. Translation output can include audio output in another language and/or transcript output in another language.

### CROSS REFERENCE TO RELATED APPLICATIONS

This application claims the benefit of priority to U.S. Provisional Patent Application No. 63/808,617, entitled “AUDIO TRANSLATION FOR DEVICE-TO-DEVICE COMMUNICATIONS”, filed on May 19, 2025, and U.S. Provisional Patent Application No. 63/819,901, entitled “AUDIO TRANSLATION FOR DEVICE-TO-DEVICE COMMUNICATIONS”, filed on Jun. 8, 2025, the disclosure of which is hereby incorporated herein in its entirety.

### TECHNICAL FIELD

The present description relates generally to audio translation, and more particularly, for example, to audio translation for communications between two or more devices.

### BACKGROUND

A phone call or video call allows people to communicate with each other over distances through a network. In some instances, one person on a phone call or video call may speak one language and another person on the phone call or video call may speak another language.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for communicating between devices, in accordance with one or more implementations.

FIG. 2 illustrates a schematic view of an electronic device for providing a translation during a communication session between devices, in accordance with one or more implementations.

FIGS. 3A, 3B, 3C, and 3D illustrate schematic diagrams showing an exemplary user interface view in which a translation is initiated and provided along with media streams for participants during a communication session in accordance with one or more implementations.

FIG. 4 illustrates a flow diagram of an example process for providing a translation during a communication session between devices in accordance with one or more implementations.

FIG. 5 illustrates a flow diagram of an example process for providing a translation during a communication session between devices in accordance with one or more implementations.

FIG. 6 illustrates a flow diagram of an example process for providing a translation during a communication session between devices in accordance with one or more implementations.

FIG. 7 illustrates a flow diagram of an example process for providing a translation during a communication session between devices in accordance with one or more implementations.

FIG. 8A illustrates an example electronic system with which aspects of the subject technology may be implemented in accordance with one or more implementations. FIGS. 8B and 8C illustrate flow diagrams for an application process implementing aspects of the disclosure, in accordance with some implementations. FIGS. 8D and 8E illustrate a device diagram and a system diagram, each of which implement aspects of the disclosure, in accordance with some implementations. FIGS. 8F and 8G illustrate a flow for an API calling module and API interface, which may be used in accordance with some implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Electronic devices, such as smart phones, tablets, and computer devices, can have telephony services applications and/or audio/video call applications installed thereon to allow users of the electronic devices to exchange audio streams and/or video streams of each other in real time, during a communication session or media session (e.g., a communication session involving source audio and/or source video) between the electronic devices. In some scenarios, it can be beneficial to provide, during the media session, a live translation of the spoken audio input that is being provided to one or more of the participant devices in the media session. For example, it can be beneficial to provide a translation of a participant's speech into another language when one participant is speaking in a language that the other participant does not understand.

Aspects of the subject technology disclosed herein can be helpful, for example, in providing translations of audio content during a media session (i.e., a video and/or audio communication session). For example, in one or more implementations, a translation can be generated at a device from data that represents audio content. The source data for the translation process can be received as audio input at the device that does the translating in one or more embodiments. The source data for the translation process can be received as audio input at a device other than the device that does the translating in one or more embodiments. In other words, the device that generates the translation can generate the translation for audio spoken by a first user into the device and/or for audio spoken by a second user into a remote device (e.g., a remote device involved in the media session with the device).

Conventional approaches for translating audio during communication sessions rely on server-side processing or stateless translation of discrete audio segments, which can result in increased latency, loss of conversational context, and inconsistencies in translation quality. In particular, conventional systems often do not maintain translation context across streaming audio segments or across different sources of audio (e.g., local and remote audio inputs), resulting in fragmented or inaccurate translations.

In contrast, the subject technology provides improvements in the technical field of real-time audio processing by maintaining a persistent translation context associated with a communication session, enabling continuous and context-aware translation of streaming audio input. The subject technology further improves synchronization of translated output with corresponding audio streams and reduces latency by performing translation operations at a device participating in the communication session.

Aspects of the subject technology can provide the translation in audio and/or text form. For example, the translation can be provided as text during a video session and as audio during an audio session, though a user may choose to include the other or both. Following the media session, a transcript of the translation and of the parts of the media session which were not translated can be provided to the devices involved in the media session.

The translations may be provided as the audio input is received by the device generating the translation. For example, the audio input can be provided locally to the device doing the translation or can be streamed to the device doing the translation, where the audio input includes words, phrases, sentences, and/or other groups of words spoken by a user of the device at which the audio input is received. As a translation engine at the device receives the audio input the translation engine can perform the translation and provide the translated output to the local device and/or one or more remote devices involved in the media session.

Aspects of the subject technology can provide further features relating to the translation process. For example, in one or more embodiments, the language spoken by each user can be detected and when the language is not in a list of preferred languages for the device, the device can prompt a user of the device to begin translation. In another example, in one or more embodiments, when a translation process is begun, the device that does the translation can provide a notice to the other device, causing the notice to be played at the other device that the translation will be occurring.

Generating the translation at one of the devices involved in the media session (i.e., a video and/or audio session) (e.g., in contrast to sending an audio stream for transcription at a server) can be advantageous because data corresponding to the source of the audio input can be obtained, learned, and/or stored by the translating device in a manner that is privacy preserving to the user and/or other users involved in the media session. Generating the translation at one of the devices involved in the media session can also be advantageous because then only the translating device needs to have the software and/or hardware capabilities to perform the translation processes for each of the other involved devices.

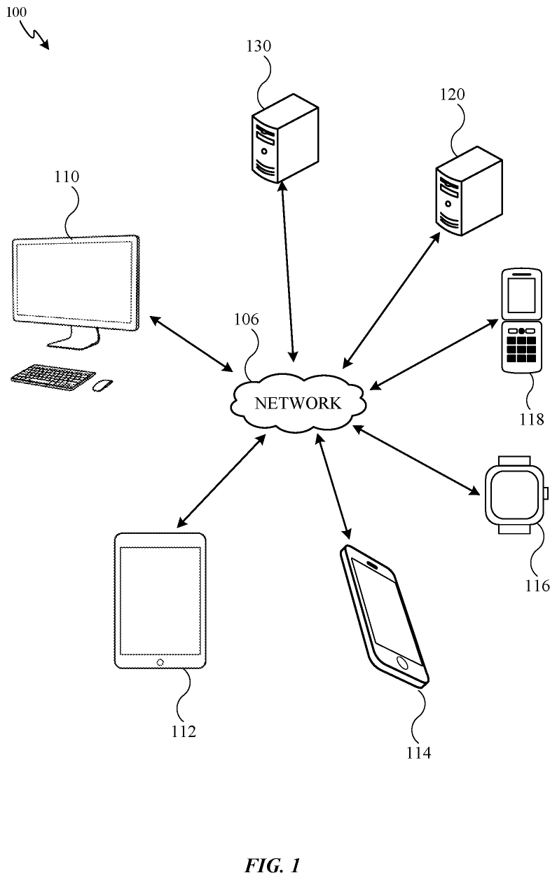

FIG. 1 illustrates an example network environment 100 in which a media session with translation may be implemented in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 112, an electronic device 114, an electronic device 116, an electronic device 118, a server 120, and a server 130. The network 106 may communicatively couple the electronic device 110, the electronic device 112, the electronic device 114, the electronic device 116, the electronic device 118, the server 120, and/or the server 130. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 112, the electronic device 114, the electronic device 116, the electronic device 118, the server 120, and the server 130; however, the network environment 100 may include any number of electronic devices and/or any number of servers communicatively coupled to each other directly or via network 106.

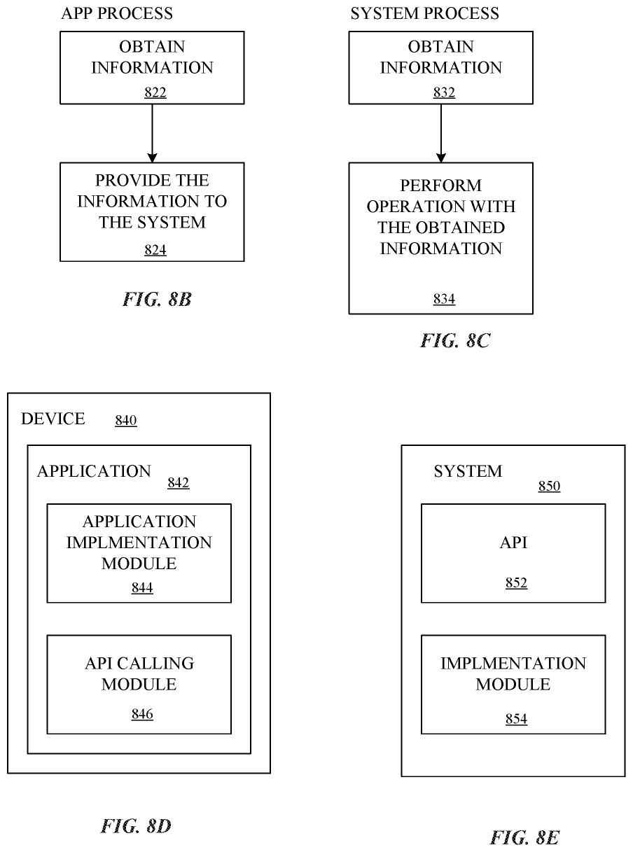

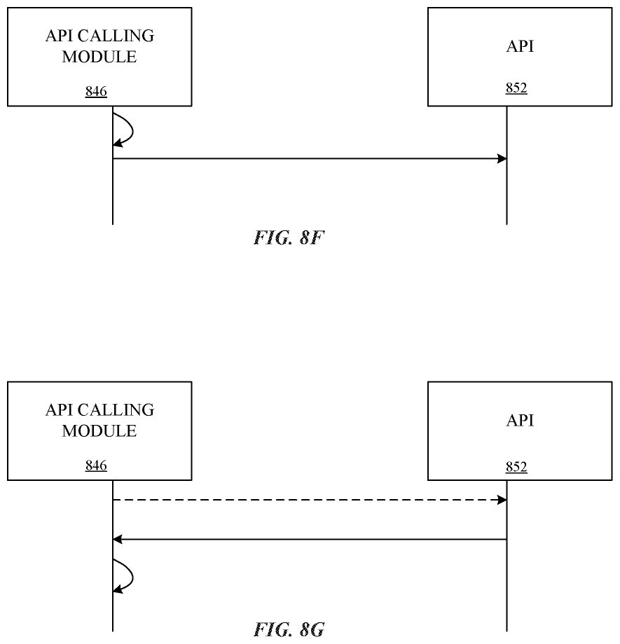

Any of the electronic device 110, the electronic device 112, the electronic device 114, the electronic device 116, or the electronic device 118 may be, for example, a desktop computer, a portable computing device such as a laptop computer, a smartphone, a peripheral device (e.g., a digital camera, headphones), a tablet device, standalone videoconferencing hardware, a wearable device such as a watch, a band, and the like, or any other appropriate device that includes, for example, one or more wireless interfaces, such as WLAN radios, cellular radios, Bluetooth radios, Zigbee radios, near field communication (NFC) radios, and/or other wireless radios. Any of the electronic device 110, the electronic device 112, the electronic device 114, the electronic device 116, or the electronic device 118 may be, and/or may include all or part of, the electronic system discussed below with respect to FIG. 8A. The electronic device 118 may also be, for example, a mobile phone, a phone having a wired interface, such as a land-line telephone or office phone, and which may be technologically able to engage in a media session with other devices (such as the electronic devices 110, 112, 114, and 116), but which is incapable of providing translation services. Some devices may be incapable due to lack of technological ability, such as hardware incapable of supporting translation services, lack of needed software, or for other reasons.

In FIG. 1, by way of example, the electronic device 110 is depicted as a desktop computer, the electronic device 112 is depicted as a tablet device, and the electronic device 114 is depicted as a smart phone, the electronic device 116 is depicted as a smart watch, and the electronic device 118 is depicted as a phone. In one or more implementations, the electronic device 110, the electronic device 112, the electronic device 114, and/or the electronic device 116 may include a translation service installed and/or accessible at that electronic device. In one or more implementations, the electronic device 116 and/or electronic device 118 may be able to engage in a media session with other devices, but may not have translation capabilities available thereon. In one or more implementations, the electronic device 110, the electronic device 112, the electronic device 114, the electronic device 116, and/or the electronic device 118 may include a camera and/or a microphone and may provide the communication services for exchanging audio streams, video streams, and/or transcriptions over the network 106, such as with a telephone application software or firmware, or such as with a video and/or audio conferencing application that is installed and accessible at, for example, one more others of the electronic device 110, electronic device 112, electronic device 114, electronic device 116, and/or electronic device 118.

In one or more implementations, one or more of the electronic device 110, the electronic device 112, the electronic device 114, the electronic device 116, and/or the electronic device 118 may have a communications application installed and accessible at the electronic device. The communications application, for example, may correspond to a video call application, a conferencing application, a video and/or audio phone application, and/or any other communications application that can provide two-party or multi-party communications between devices. In one or more implementations, one or more of the electronic device 116 and/or the electronic device 118 may not have a translation service available at that electronic device. In one or more implementations, one or more of the electronic device 110, the electronic device 112, the electronic device 114, and/or the electronic device 116 may have a translation service available at the electronic device and when engaged in a media session with a device that does not have a translation service, may provide translation services.

In one or more implementations, one or more servers such as the server 120 and/or the server 130 may perform operations for managing secure exchange of audio and/or video streams between various electronic devices such as the electronic device 110, the electronic device 112, the electronic device 114, the electronic device 116, and/or the electronic device 118, such as during a media session (e.g., a video and/or audio call or conferencing session). In one or more implementations, the server 120 may store account information associated with the electronic device 110, the electronic device 112, the electronic device 114, the electronic device 116, the electronic device 118, and/or users of those devices. In one or more implementations, one or more servers such as the server 130 may provide resources (e.g., web-based application resources), for managing and/or tracking the capabilities of the electronic devices to perform translation services and/or tracking whether the translation services are active for a particular communication involving two or more of the electronic devices.

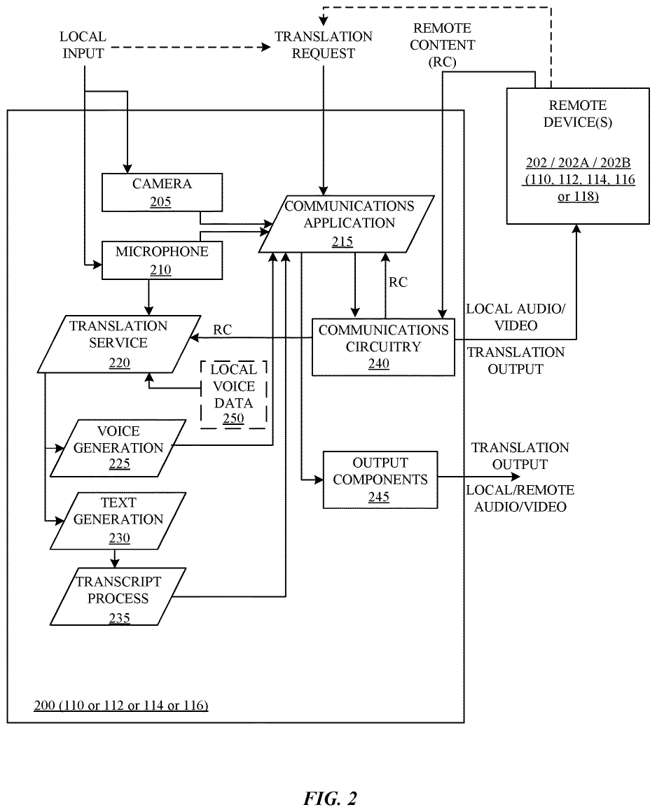

FIG. 2 schematically illustrates various hardware and software features of an electronic device that can generate and provide translations during a media session, such as an audio and/or video call. In the example of FIG. 2, rectangular boxes are used to indicate hardware components, and trapezoidal boxes are used to indicate software processes that may be executed by one or more processors of the electronic device. Each of the elements are labeled with underlined reference labels.

As shown in FIG. 2, an electronic device 200, such as electronic device 110, 112, 114, or 116, may include one or more cameras such as camera 205, one or more microphones such as microphone 210, communications circuitry 240 such as corresponding to radios and/or wireless interfaces, output components 245 (e.g., a display and/or one or more speakers).

A translation service 220 may be installed and/or running at the electronic device 200. In the example, of FIG. 2, the translation service 220 is shown as a separate service, however, in one or more implementations, it may be integrated into the communications application 215. As shown in FIG. 2, local input (e.g., audio input to the microphone 210 and/or video input to the camera 205) may be received by the electronic device 200. For example, the user of the electronic device 200 may speak into the microphone and/or capture video images of their self while they are speaking.

In one or more implementations, the translation service operates as a pipeline that processes streaming audio input in successive stages, including speech recognition, language translation, and output generation, where each stage processes segmented portions of the audio input as the audio input is received. The stages may operate concurrently on different segments of the audio stream to reduce end-to-end latency.

The electronic device may maintain intermediate data structures representing partially processed segments, allowing downstream stages to begin processing before upstream stages have completed processing the entire audio stream.

As shown, the local input may be provided from the camera 205 and/or the microphone 210 to a communications application 215 running on the electronic device 200. The communications application 215 may generate an audio stream and/or a video stream (e.g., an audio capture and/or video capture stored in an electronic format that may be streamed and/or stored) from the local input (e.g., local audio/video) and provide the audio stream and/or a video stream to the communications circuitry 240, for transmission to one or more other electronic devices, such as the electronic device 110, the electronic device 112, the electronic device 114, the electronic device 116, and/or the electronic device 118 (e.g., for output at the receiving device) during a media session with the one or more other electronic devices.

FIG. 2 also shows that an audio input portion of the local input may be provided to the translation service 220. In one or more implementations, the translation service 220 may generate a translation of the audio input and provide it to a voice generation module 225 and/or a text generation module 230. The text generation module can provide the text to a transcript process 235 that can generate a transcript of the generated translated text as well as a transcription of the audio input portion from the microphone 210. The output of the voice generation module 225, the text generation module 230, and/or the transcript process 235 can be referred to as translation output. The output of the voice generation module 225 may include an audio stream including a computer-generated vocal of the translation output. In one or more implementations, the style of the voice (e.g., voice accent, gender, idiosyncrasies) may be user-selectable.

In one or more implementations, the translation service 220 can translate an audio input (e.g., the audio input portion of the local input and/or an audio input portion of remote content) by a process including transcribing the audio input into a textual representation of the audio input in the same language as the audio input was provided in, e.g., in a speech-to-text operation. Next, the transcription can be translated using a translation engine. The translation engine may be stored on the device within the translation service 220. The translation process can produce a target language transcription of the transcribed input, or in other words can translate the transcribed input into a translated transcription. This translated transcription can be provided to the voice generation module 225 for generating an audio version of the translated transcription, e.g., in a text-to-speech operation. The translated transcription can be provided to the text generation module 230 which can perform additional processing to format the translated transcription, which can then be provided to the transcript process 235 which can combine the translated transcription with one or more of the original transcribed input, the original transcribed input based on the remote content, and/or the translated transcription of the transcribed input based on the remote content.

FIG. 2 also shows that remote content can be provided to the communications circuitry 240, for example, from one more remote devices 202 (e.g., one or more of the electronic devices 110, 112, 114, 116, and/or 118) involved in a media session with the electronic device 200. The remote content, for example, can correspond to audio and/or video content received at the electronic device 200 which is provided by the one or more remote devices 202. The remote content can be received in segments or streamed so that the remote content is received and processed in segments. The communications circuitry 240 can provide the remote content (specifically, audio content of the remote content) to the translation service 220. In one or more implementations, the translation service 220 may generate a translation of the remote content and provide the translated remote content to the voice generation module 225 and/or the text generation module 230. The text generation module 230 can provide the text to the transcript process 235 that can generate a combined transcript of the generated translated text as well as a transcription of the remote content.

In one or more other implementations, the translation of the audio input and/or the remote content can be generated by the communications application 215 (e.g., the translation service 220 may be implemented as an integral part of the communications application 215).

The communications application 215 may also provide the translation output to the communications circuitry 240 for transmission to one or more other electronic devices, such as the electronic device 110, the electronic device 112, the electronic device 114, the electronic device 116, and/or the electronic device 118 during a media session. In one or more other implementations, the translation output can be provided directly to the communications circuitry 240 for transmission.

In one or more implementations, the translation output can be generated and transmitted in segments, so that each segment of the translation can be provided at a received device (e.g., the local device (electronic device 200) or the remote device 202 (which may correspond to another electronic device 200)) as the corresponding audio input and/or remote content is being provided to the electronic device 200. The translation service 220 or the communications application 215 may generate time information for the translation. The time information can be used to synchronize the translation with the local audio/video when the local audio/video and the translation are rendered at a receiving device and/or local device.

In one or more implementations, the electronic device generates timing metadata associated with both the audio input and the translation output, including segment boundaries, timestamps, and latency offsets. The timing metadata can be used to dynamically align translated audio output with corresponding portions of original audio, including compensating for processing delays introduced by speech recognition, translation, and voice synthesis operations.

In some implementations, the electronic device may adaptively adjust buffering, segment size, or processing cadence based on detected network latency, processing load, or characteristics of the audio input to maintain synchronization between the audio stream and the translation output. In one or more implementations, the electronic device monitors for interruptions in audio input, network communication, or processing availability and maintains the translation session in a recoverable state. For example, the electronic device may buffer untranslated audio segments during a temporary interruption and resume translation processing when the interruption is resolved. The electronic device may also maintain translation context across such interruptions to avoid restarting translation from an initial state.

As illustrated in FIG. 2, for translations involving local input, the translation service 220 may use local voice data 250 to aid in generating the translation of an audio portion of the local input in one or more implementations. For example, the local voice data 250 may include one or more stored and/or learned attributes (e.g., frequency characteristics, commonly used words or phrases, and/or voice models at the electronic device 200 that have been trained on voice inputs from the user of the electronic device 200) of the voice of the user of the electronic device 200. In this way, the translation service 220 at the electronic device 200 may leverage its own preexisting knowledge of the user of the electronic device 200 to generate transcriptions of spoken input by that user that are higher quality than would be otherwise possible by a general translation service for generic voices (e.g., a translation service provided by a server or another device of another user).

In one or more implementations, the electronic device maintains device-specific voice data associated with a user and utilizes the voice data to adjust parameters of a speech recognition model used in the translation process. For example, the electronic device may adapt acoustic models, pronunciation models, or language models based on previously observed speech patterns of the user.

In some implementations, the adaptation may occur incrementally during the communication session such that recognition accuracy improves over time as additional audio input is received. This localized adaptation may be performed without transmitting user-specific voice data to external systems.

As illustrated in FIG. 2, the communications application 215 can provide the local input and/or remote content for output by the output components 245 during the media session. The output components 245 may include, for example, a display screen for displaying video content and/or one or more speakers for providing audio content. In this way, the user of the electronic device 200 can see their own outgoing video stream (if engaged in a video media session) and see the video stream of the one or more remote participants (i.e., video portion of the remote content) and/or hear the audio stream of the one or more remote participants (i.e., audio portion of the remote content). Translation output can also be provided to the output components 245 from the communications application 215. The translation output can include transcripts displayed on the display screen and/or an audible translation (e.g., as an output of the voice generation module 225) of the remote content and/or the local content provided to the one or more speakers. In one or more implementations, the translation output can be provided directly to the output components 245 from the translation service 220. In one or more implementations, when the translation output includes a generated voice output, the translation output can combine the original audio (e.g., the audio portion of the local input) with the translated output (e.g., the voice generated output from the voice generation module 225) and provide that to the communications circuitry 240 directly or to the communications application 215 to provide to the communications circuitry 240.

As shown in FIG. 2, a translation request can be received by the communications application 215. In some implementations, the translation request, for example, can be received as an input to the local device, for example, from a user of the device providing an instruction to request translation services at the electronic device 200. In other implementations, the translation request can be received from one or more remote devices 202 involved in a media session. For example, a user of a remote device 202, may select an option to request the translation output on their device, which causes a translation request to be sent to the electronic device 200. Upon receipt of the translation request, the user of the local device, can authorize or accept the request and provide the translation(s) as described herein to the local device and/or the one or more remote devices 202. In one or more implementations, when one of the electronic devices in the media session begins providing translation services, it can be configured to provide translation services for all of the electronic devices involved in the communication. In such implementations, the device providing the translation services can provide information to a server, such as the server 120, which can track the translations involved (e.g., in a privacy preserving manner) and disable an option on the remote devices 202 (e.g., causing a translation option to be unavailable) to begin translation services. In some implementations, an option at one or more of the remote devices 202 can cause a translation request to the electronic device 200 while the translation process is ongoing which causes the translation process to stop at the electronic device 200 and resume at another one of the remote devices 202, thereby switching the translation process to one of the remote devices 202.

In one or more implementations, to avoid conflicting or redundant translation operations among multiple devices in a communication session, a coordination mechanism is employed in which a single device is designated as a translation provider. The designation may be communicated using signaling messages exchanged between devices or via a server.

The electronic device may disable or suppress translation functionality at other devices and maintain exclusive control over translation processing for the communication session. In this manner, the subject technology reduces computational redundancy, avoids inconsistent translation outputs, and improves synchronization of translated content across devices.

In the following discussion, an example media session is described between an electronic device 200 (e.g., a device having the capability to implement the subject services) and a remote device 202. When the remote device also has the capability to implement the subject technology (e.g., is a second electronic device 200), the remote device may be referred to as a remote device 202A. When the remote device does not have the capability to implement the subject technology (e.g., has older software, older hardware, or has an incompatible system), the remote device may be referred to as a remote device 202B. When either a remote device 202A with the subject technology or a remote device 202B without the subject technology may be used, then the remote device may be referred to as remote device 202. For ease of discussion, only one remote device 202 is referenced for a media session between an electronic device and a remote device 202. However, it should be understood that multiple remote devices 202 may be involved in a media session (e.g., a group voice or video session or call).

In an operational scenario between an electronic device 200 and one or more remote devices 202, the translation services can begin by determining, by the electronic device 200, that translation services are needed. The determination can be made, for example, prior to the media session in the case that the electronic device 200 requests to be connected in a media session with the remote device 202, based on location information associated with the remote device 202 The location information may be derived, for example, from an area code or country code of a phone number associated with the media session or may be derived from an address of a contact associated with the remote device. The location information can suggest, for example, that the location of the remote device 202 is associated with a spoken language which is different than the spoken language of a user of the electronic device 200. In some instances, the determination can be made prior to the media session in the case that the electronic device 200 receives a request to be connected in a media session with a remote device 202, for example, based on the location information associated with the remote device 202. In other words, when an electronic device 200 places a voice or video call to a remote device 202 or receives call from a remote device 202, language information associated with location information of the remote device 202 can be used to predict whether translation services will be needed. The determination may also be made based on a prior activity with regard to the remote device 202. For example, if a previous media session between the electronic device 200 and the remote device 202 utilized translation services, then the electronic device 200 may determine that location services are likely needed or are likely to be requested in the upcoming media session.

In such instances where the electronic device 200 determines that translation services are likely to be needed, prior to or in conjunction with the media session beginning, the translation services can begin automatically on the electronic device 200 or may be suggested or prompted on the electronic device 200, which a user of the electronic device 200 may accept or decline. In other implementations, the translation services can be automatically started or suggested or prompted on the electronic device 200 after the media session is established.

In some implementations, after a media session is established between the electronic device 200 and the remote device 202, the electronic device 200 can detect that a language spoken at the remote device 202 and transmitted to the electronic device 200 is a language that the user of the electronic device 200 would want translated into another language, based on settings previously stored in the electronic device 200. For example, if the user's preferred language is English, the electronic device 200 can detect that a spoken language streamed from the remote device 202 is not English. In some instances, the electronic device 200 can further detect which language is being spoken into the remote device 202. For example, the electronic device 200 can determine that the remote content is in German (or another language) using any suitable means, such as pattern matching (e.g., matching vocalizations in common greeting phrases) and/or as an output of one or more machine learning models trained to predict which language is represented by an input waveform. In such instances, upon detecting the language, the translation services can begin automatically on the electronic device 200 or may be suggested or prompted on the electronic device 200, including specifying the source language (e.g., German in this example) based on the detected language and the target language (e.g., English in this example) based on the user's preferences, which the user of the electronic device 200 may accept or decline.

In some implementations, after initiation of the translation session and prior to the beginning of the translation process provided by the translation service 220, the electronic device 200 can generate or provide a stored message from the electronic device 200 to the remote device 202, e.g., via the communications circuitry 240, that an automated translation process is about to commence. The level of detail of the message and or waiting periods after the message is provided can be based on the geographic region of the remote device 202. For example, the subject technology contemplates that different geographic regions may have different customs, rules, or regulations regarding automated translation or use of a user's data by an electronic device and consent. In some implementations, the translation service 220 may not perform translations until the user of the remote device 202 indicates consent, for example, by speaking an affirmation of consent or pushing a button on their phone or key on their device. The message that is generated or stored can correspond to the language which is going to be translated. Continuing in the current example, since the language that is going to be translated from the remote content from the remote device 202 is German, the notice can be provided to the remote device 202 in German. The message can also be provided at the electronic device 200 in the native language associated with the electronic device 200, which is in this case English. A consent may also be required of the device of the local user, however, the initiation of the translation may be considered consent, in accordance with one or more implementations.

In addition to translation services being initiated on the electronic device 200, in one or more implementations, the translation services can be requested by the electronic device 200 to be provided from the remote device 202A (supporting the translation services). The translation services may be requested by the electronic device 200, for example, when battery power is low on the electronic device 200, when the electronic device 200 is set in a particular mode, such as a mode to optimize battery power or to provide distraction free and/or hands free driving, or when settings of the electronic device 200 instruct the electronic device 200 to request translation services rather than provide translation services. The request for translation services can include a request to translate the remote content provided by the remote device 202A into translated output for use at the electronic device 200. In some implementations, the request for translation services can include a request to translate the local content provided by the electronic device 200 to the remote device 202A for translation. If the remote device 202A agrees to provide translation services, then the electronic device 200 can receive a disclosure message that translation is about to take place, such as noted above, however, the disclosure message may be generated at the electronic device 200 or the remote device 202A. After translation begins, remote content from the remote device 202A can be provided to the electronic device 200 that includes translated output in addition to the originally provided remote content. For example, the remote content can include a combination of one or more media streams including original audio, translated audio, video, original transcripts, and/or translated transcripts.

In one or more implementations, a communication session between electronic devices may transition between different communication modalities or services while maintaining an active translation session. For example, a communication session that is initially established as an audio call using a telephony service may be upgraded to a video call using a video conferencing service (e.g., a Voice over Internet Protocol (VoIP) or multimedia communication application) during the course of the communication. In such implementations, the electronic device may maintain the translation session across the transition between the different communication services such that translation of audio input continues without requiring additional user input to restart or reconfigure the translation session.

In one or more implementations, the electronic device may detect a transition or upgrade of the communication session from a first communication service to a second communication service based on signaling information, application state changes, operating system events, or other indicators that the underlying communication modality has changed. In response to detecting the transition, the electronic device may transfer or adapt one or more translation parameters associated with the translation session, including language selection, user preferences, transcription state, and/or voice generation settings, for use with the second communication service.

In one or more implementations, the translation service may operate independently of a particular communication application such that the translation session is associated with the communication session at a device level rather than being limited to a specific application instance. In this manner, translation processing of audio input captured at the electronic device or received from a remote device can continue seamlessly as the communication session transitions between different communication services.

In one or more implementations, translation data, including partial transcripts, buffered audio segments, and/or context information associated with the translation model, may be preserved across the transition to enable continuity of translation output. For example, a partially processed segment of audio captured prior to the transition may be completed and output after the transition, and subsequent audio captured after the transition may be translated using the same translation context without interruption.

In one or more implementations, the continuation of the translation session across the transition between communication services may occur automatically without requiring any user input beyond the actions that initiated the transition of the communication session. Accordingly, the user experience may be improved by allowing a user to upgrade or otherwise change the communication modality (e.g., from an audio call to a video call) while maintaining uninterrupted translation of the communication.

In one or more implementations, the electronic device 200 and the remote device 202A can each perform its own translations, e.g., using the translation service 220, and provide the translation output to the other device.

In one or more implementations, when the remote device 202 corresponds to a remote device 202B (which does not support the translation services), the user at the remote device 202B can request translation services from the electronic device 200. The remote device 202B may request translation services by using a key press on the keypad of their phone, for example, using a telephone keypad that transmits certain tones corresponding to the different keys on the keypad. The electronic device 200 can receive the key press tones and determine what keys were pressed and initiate and/or prompt the user at the electronic device 200 to initiate translation services. For example, if the keys 22 or 2*# are detected (or some other key combination), then the key press can be received at the electronic device 200 as a translation request. In some implementations, different languages can be assigned to different key combinations. For example, if Italian is 08, then the keypress may correspond to *08 # at the remote device to request translation services in particular language. In other implementations, where the electronic device 200 receives the key presses from the remote device 202B as a translation request, the user at the electronic device can select which languages the local input is translated into and provided to the remote device 202B via the communications circuitry 240. Where a key press may not be available or in other implementations, the translation services can be requested at the remote device 202B by a voice command provided by the user at the remote device 202B and transmitted to and received by the electronic device 200. In such implementations, the received voice command can be detected by the electronic device 200, processed as a translation request, and the translation process can be initiated at the electronic device 200. The voice command can include a desired target language to translate into.

In an operational scenario, when the electronic device 200 provides the translation output to the output components 245 of the electronic device 200 (whether that translation output is provided by the electronic device 200 from the translation service 220 or whether that translation output is provided by the remote device 202A from its translation service 220) the translation output can be provided to the output components 245 in several different ways, depending on the options selected by the user. For example, in an audio media session (such as a telephone call), the translation output can be provided as a computer-generated vocal corresponding to the translation. In some implementations, the original audio (pre-translation) can also be provided to the output components 245, for example, at a softer volume and the translation output can be provided at a louder volume. In other implementations, only the translation output is provided. When the translation output is provided by the translation service 220, the communications application 215 can optionally, provide the original audio captured by the microphone 210 as well as the translation output generated by the voice generation module 225 to the output components 245.

In a variation of the operational scenario, when the translation output is provided by the remote device 202A as remote content for delivery on the electronic device 200, in some implementations, the voice generation module 225 of the electronic device 200 can be used to generate the voice of the translation. In other words, the translation output can be received by the electronic device 200 in a textual data representation and generated as audio output by the voice generation module 225 which can read, using a computer-generated voice, the translation output via the output components 245. In other implementations, the remote device 202A may provide the original audio stream as well as the translated audio stream, e.g., produced by the voice generation module 225 of the remote device 202A. In such implementations, the remote device 202A may provide them as separate streams and the communications application 215 of the electronic device 200 may control the delivery of each of the audio streams to the output components 245. Alternatively, the remote device 202A may provide them as a single stream including both audio components (the original audio and the translated audio). For any of these implementations, it should be understood that providing the original audio to the output components 245 is optional and in such instances, only the audio corresponding to the translated output may be provided.

In accordance with one or more implementations the user at the electronic device 200 or remote device 202A receiving the translation output may choose to repeat the user's own translation output. This may be useful if the user has some understanding of the language that is being translated into, for example, for hearing that the translation is correct. It may also be useful for pacing in the conversation, as the user speaking the original language can hear the translation output at approximately the same time as the other user receiving the translation.

Translation output may be provided as a streamed output to the output components 245. The audio input into the translation service 220 may be continually provided to the translation service 220 in an audio stream and the translation service 220 may provide translation output as an output audio stream via the voice generation module 225. As such, the user need not stop and pause for translations to be processed.

In the above operational scenario, transcripts may also be provided of the translation. The electronic device 200, for example, can provide live transcripts of the input audio and the translated output to a display screen of the electronic device 200, during the media session. The translation output can be provided to the text generation module 230 which can provide the text generated translation output to a transcription process which can interleave and organize original transcript data provided by a separate transcription process (or by an instance of the text generation module 230). The transcript process 235 may provide a complete transcript from each of the devices involved in the media session. For example, the remote content can be provided to the transcript process 235 to combine the remote content with the text generated output of the translation output to set forth a full transcript. The full transcript may optionally include both the untranslated audio input and the translation output for each of the translated audio inputs in some implementations, while in other implementations, the full transcript may include only the translation output for the translated audio inputs. In both implementations, any audio input that was not translated can also be provided in the transcripts.

In one or more implementations, the transcripts can be live transcripts which are streamed to the output components 245 of the electronic device 200 and/or the remote device 202A. The transcripts can be generated and provided by one of the devices in the media session and streamed to each of the other participating (but not translating) devices upon request.

In some implementations, a text transcript of the translations may be provided as the translation output and an audio output of the translation output may not be provided. For example, in a video call, it may detrimentally impact user experience to see a participant's mouth move while the translated audio would not match the participant's mouth. In such instances, the user may opt to only display translation output in a transcript area of the display screen.

In the above operational scenario, it should be understood that the translating device (e.g., the electronic device 200 or the remote device 202A) can provide the translations for all devices in the media session. The translations may include translation audio output and/or translation text output. The translation at the electronic device 200 or remote device 202A can also include translations provided to a device without the translation capabilities, e.g., remote device 202B, as well as translations of audio input received as remote content from the remote device 202B without the translation capabilities.

At the conclusion of the media session, transcripts of the media session, including the translation text can be provided to the other devices from the media session, in accordance with some implementations. In some implementations, for example, an option can be provided on the electronic device 200 and/or the remote device 202A to download the media session transcripts. A text message or other communication can be provided to the remote device 202B that includes an attached version of the transcript or a link to the transcript.

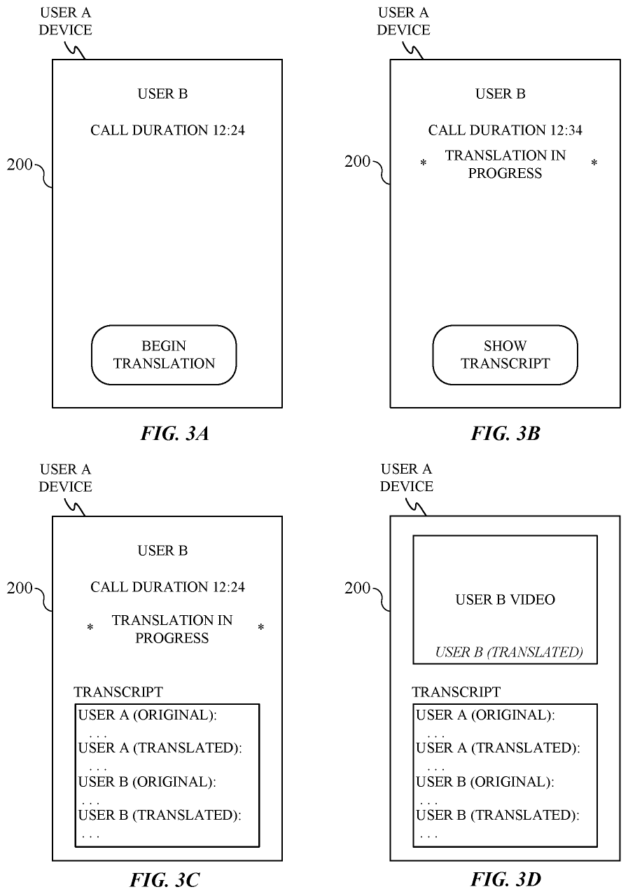

FIGS. 3A, 3B, 3C, and 3D illustrates an example of electronic device 200 during a media session using a communications application, such as communications application 215 running at the electronic device 200. The electronic device 200 may include the features described above with respect to FIG. 2. In the example of FIGS. 3A, 3B, and 3C, the media session is represented as an audio only session and in the example of FIG. 3D, the conferencing session is represented as a video session using a video communications application running at the device, for illustrative purposes.

As shown in FIG. 3A, during a media session between the USER A device and the USER B, the communications application can provide a button for input at the USER A device to begin translation of the media session. The button can be provided in response to detecting that the USER B is beginning to speak a different language, for example. The button can be provided in response to determining that location information associated with the USER B indicates that a translation of audio input corresponding USER A and/or USER B may be needed. The button can be provided in response to determining that a previous interaction between USER A and USER B utilized translation services.

As shown in FIG. 3B, after the user selects to begin the translation of the media session, an indicator that the media session is being translated may be provided. Although the interface shown is for the electronic device 200, it may be similarly displayed at the remote device 202A that a translation is in progress, for example, after providing at the remote device 202A and/or remote device 202B a disclosure that the media session will be recorded. After the translation process begins, an additional input option may be provided for display at the electronic device 200. The additional input option may provide the ability to show a transcript of the translation.

As shown in FIG. 3C, when the transcript button is selected, a live, streaming transcript can be shown on the display screen of the electronic device 200. The transcript may show, for example, both original and translated textual output corresponding to the translated audio input, although the user may hide or deselect one or more of the transcript elements from appearing.

As shown in FIG. 3D, the electronic device 200 shown in FIG. 3D includes a camera that obtains a continuous stream of image frames that are provided to the media session for viewing by the user of electronic device 200 (e.g., a USER A) and/or for transmission to one or more other participant devices such as remote devices 202A and/or 202B (e.g., for one or more remote users, such as USER B in this example (or USER C or USER D)). As described herein, audio input received at the electronic device 200 (e.g., using the microphone 210 of FIG. 2) can also be transmitted from the electronic device 200 to the electronic devices of one or more remote users (e.g., USER B, USER C, and USER D).

In various examples, a transcription is generated by an electronic device and provided to one or more other electronic devices participating in a conferencing session based on a request from the one or more other electronic devices. In other examples, the transcription can be generated responsive to a reduction in bandwidth for the conferencing session. For example, one or more of the electronic devices and/or a server relaying information for the conferencing session may determine that the bandwidth for one or more of the electronic devices has become too low for exchanging audio and/or video data, and a transcription may be provided in lieu of the audio and/or video data (e.g., until an increase in bandwidth is detected).

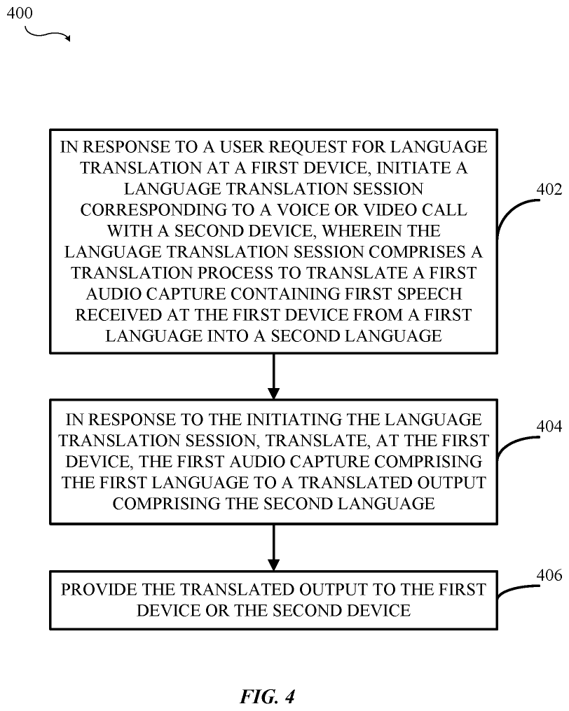

FIG. 4 illustrates a flow diagram of an example process 400 for providing a translation during a media session, in accordance with one or more implementations. For explanatory purposes, the process 400 is primarily described herein with reference to the components of FIG. 1 and FIG. 2 (particularly with reference to electronic device 200 (e.g., electronic device 110, electronic device 112, electronic device 114, and/or electronic device 116), which may be executed by one or more processors of the electronic device 200 of FIG. 2. However, the process 400 is not limited to the electronic device 200, and one or more blocks (or operations) of the process 400 may be performed by one or more other components of other suitable devices, such as one or more of the electronic devices 110, the electronic device 112, electronic device 114, and/or the electronic device 116. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

As shown in FIG. 4, process 400 at block 402 may include, in response to a user request for language translation at a first device, initiating a language translation session corresponding to a voice or video call with a second device, where the language translation session comprises a translation process to translate a first audio capture containing first speech received at the first device from a first language into a second language. In one or more implementations, a user can request at a first device, such as the electronic device 200, to initiate a language translation session to translate audio that is provided at the first device, e.g., by the user, or audio that is provided at the second device, e.g., by a second user of the second device.

The user request may correspond to a selection provided by the user of the first device to an input element displayed at the first device to begin the translation process during the voice or video call. In one or more implementations, the first language is different from a preferred language preset on the first device where the second language corresponds to the preferred language preset. In one or more implementations, the process 400 may include detecting the first language from the first audio capture, and in response to the detection of the first language, providing a prompt on the first device to initiate the language translation, where the user request is received via the prompt.

In one or more implementations, the process 400 may also include determining that the second device is associated with a geographic region associated with the second language, based at least in part on an area code or contact location information associated with the second device. In response to the determination that the second device is associated with the geographic region associated with the second language, the first device may provide a prompt on the first device to initiate the language translation, where the user request is received via the prompt. In some instances, providing the prompt occurs before the voice or video call is established.

As also shown in FIG. 4, process 400 at block 404 may include, in response to the initiating the language translation session, translating, at the first device, the first audio capture having the first language to a translated output having the second language.

As further shown in FIG. 4, process 400 at block 406 may include providing the translated output to the first device or the second device.

In one or more implementations, process 400 may further include receiving a request at the first device from the second device to provide a language translation. In response to receiving the request to provide the language translation, providing a prompt on the first device to initiate the language translation, where the user request is received via the prompt. For example, the second device may request from the first device to provide translation services, for example, of audio provided by the first user at the first device and/or for audio provided by the second user at the second device. In some instances, for example, when the second device does not have the capability or software updates to interact with the translation system available at the first device, the request is received as a sequence of one or more numeric telephone key tones. For example, the second user at the second device, can request the first device provide translation services based on input number on a telephone keypad.

In one or more implementations, the first audio capture is provided by the user of the first device and captured by a microphone of the first device, and where the first audio capture and the translated output is provided to the second device from the first device. In addition or alternatively, the first audio capture may be provided by the second user of the second device and captured by a microphone of the second device and transferred to the first device, where the first audio capture and the translated output is output by a speaker of the first device..

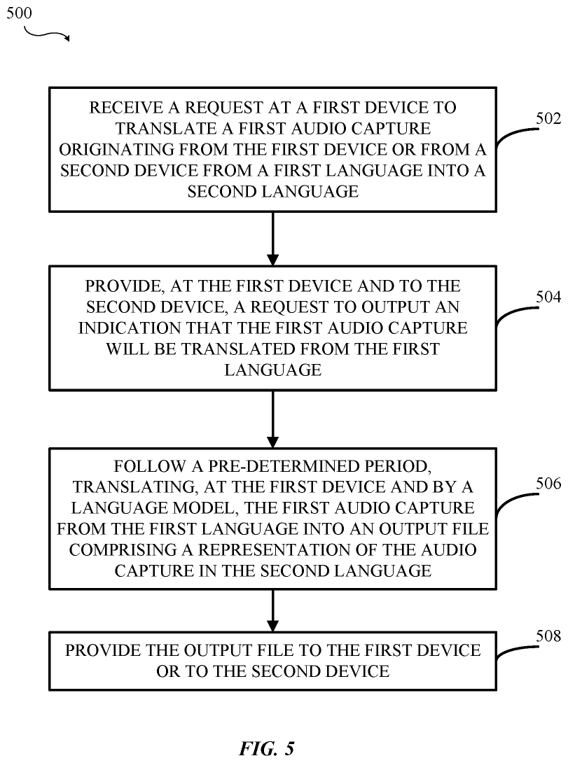

FIG. 5 illustrates a flow diagram of an example process 500 for providing a translation during a media session, in accordance with one or more implementations. For explanatory purposes, the process 500 is primarily described herein with reference to the components of FIG. 1 and FIG. 2 (particularly with reference to electronic device 200 (e.g., electronic device 110, electronic device 112, electronic device 114, and/or electronic device 116), which may be executed by one or more processors of the electronic device 200 of FIG. 2. However, the process 500 is not limited to the electronic device 200, and one or more blocks (or operations) of the process 500 may be performed by one or more other components of other suitable devices, such as one or more of the electronic devices 110, the electronic device 112, electronic device 114, and/or the electronic device 116. Further for explanatory purposes, the blocks of the process 500 are described herein as occurring in serial, or linearly. However, multiple blocks of the process 500 may occur in parallel. In addition, the blocks of the process 500 need not be performed in the order shown and/or one or more blocks of the process 500 need not be performed and/or can be replaced by other operations.

As shown in FIG. 5, process 500 at block 502 may include receiving a request at a first device to translate a first audio capture originating from the first device or from a second device from a first language into a second language. A first user for example, at the first device, can request via an interface provided at the first device to translate audio provided at the first device (e.g., from the first user speaking) from a first language to a second language and/or to translate audio provided at the second device (e.g., from a second user at the second device speaking) from a first language to the second language. In one or more implementations, the first device and the second device may be participating in a video or telephone call, for example, with zero or more other devices and their corresponding users.

As also shown in FIG. 5, process 500 at block 504 may include providing, at the first device and to the second device, a request to output an indication that the first audio capture will be translated from the first language. In response to the request, an indication can be provided by the first device to the second device that a translation process will begin. For example, the indication can be an audio output (such as a computer-generated announcement) that can be provided in the first language that the second user's speech will be machine translated into another language and may include that the other language corresponds to the second language. In another example, the indication may be a message provided to the second device, which the second device can then provide to the second user. The second user may be given an opportunity to decline the translation process, such as by pressing an input at the second device or by speaking affirmation or declination of the translation process, or simply by terminating the media session. The process of accepting or declining the translation process may vary by jurisdiction or geographic region based on rules, regulations, and/or local customs. In some implementations, an indication can also be provided, at the first device, that the first audio capture will be translated from the first language into the second language. For example, the screen of the first device may indicate that a translation session is active.

As further shown in FIG. 5, process 500 at block 506 may include following a pre-determined period, translating, at the first device and by a language model, the first audio capture from the first language into an output file having a representation of the audio capture in the second language. The output file may be a streaming output file to be provided in sequential parts to output components at the first device or to the second device for output via output components at the second device.

As also shown in FIG. 5, process 500 at block 508 may include providing the output file to the first device or to the second device. As noted above, the output file may be streamed to the first device or the second device. The output file may correspond to a translation output including a vocal representation (such as a computer-generated voice) of the translation and/or a textual representation (e.g., transcript) of the translation. In some instances, the textual representation, such as the transcript, can be read by a computer-generated voice that is generated at the second device based on the textual representation.

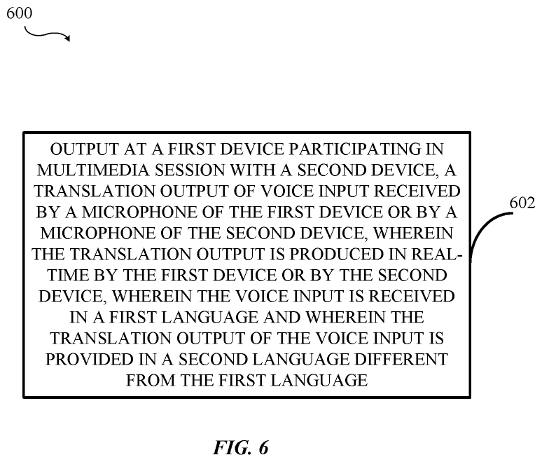

FIG. 6 illustrates a flow diagram of an example process 600 for providing a translation during a media session, in accordance with one or more implementations. For explanatory purposes, the process 600 is primarily described herein with reference to the components of FIG. 1 and FIG. 2 (particularly with reference to electronic device 200 (e.g., electronic device 110, electronic device 112, electronic device 114, and/or electronic device 116), which may be executed by one or more processors of the electronic device 200 of FIG. 2. However, the process 600 is not limited to the electronic device 200, and one or more blocks (or operations) of the process 600 may be performed by one or more other components of other suitable devices, such as one or more of the electronic devices 110, the electronic device 112, electronic device 114, and/or the electronic device 116. Further for explanatory purposes, the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

As shown in FIG. 6, process 600 at block 602 may include outputting at a first device participating in media session with a second device, a translation output of voice input received by a microphone of the first device or by a microphone of the second device, where the translation output is produced in real-time by the first device or by the second device, where the voice input is received in a first language and where the translation output of the voice input is provided in a second language different from the first language. The first device can output the translation of voice input. The voice input may be provided at the first device or the second device and the translation of the voice input may be generated at the first device or the second device. For example, the first device may send audio data representing the voice input (e.g., an audio stream) to the second device where the second device performs the translating so that the user of the second device can understand the user of the first device. As another example, the first device may send audio data representing the voice input (e.g., an audio stream) to the second device where the second device performs the translating and provides the translated output (e.g., as another audio stream) back to the first device for use at the first device. As another example, the second device may send audio data representing the voice input (e.g., as an audio stream) to the first device where the first device performs the translating so that the user of the first device can understand the user of the second device. As yet another example, the second device may send audio data representing the voice input (e.g., as an audio stream) to the first device where the first device performs the translating and provides the translated output (e.g., as another audio stream) back to the second device for use at the second device.

In one or more implementations, the first device may also output a first output corresponding to the voice input at a first volume level, and output the translation output at a second volume level greater than the first volume level. For example, the first device can output the original audio voice input at a reduced volume and then output the translated output over the original audio at a louder or normal volume. The translated output can be provided after providing words or phrases in the original voice input, or the translated output can be rendered over the original voice input such that both can be heard at the same time, but that the original voice input is output at a lower volume than the translation output. The translation output can be provided in a computer-generated voice based on a user-selected style. For example, the user can select a male voice, a female voice, a voice that has a particular accent, voices with different tonal qualities, and voices that combine such options.

In one or more implementations, a user input can be received at the first device that indicates a selection of a transcript. In response, a real-time transcript of the translation output can be streamed to the first device. In some instances, the user input can be provided at the first device and the transcript is streamed to a display screen of the first device. In some instances, the user input can be provided at the second device and the transcript is streamed to the second device, thereby causing the second device to display transcripts on a display screen of the second device. In some instances, the real-time transcript may be provided by the second device, for example, when the second device is performing the translation process, the second device can also provide the transcriptions. In one or more implementations, the real-time transcript includes a transcript of the voice input and the translation output. The transcript can include this for translations of both voice input provided at the first device and voice input at the second device.

In one or more implementations, the process 600 can also include terminating the media session and providing a prompt to a user interface of the first device to obtain a transcript of the media session. The process 600 can further include obtaining the transcript of the media session, where the transcript includes a transcript of the voice input, a transcript of the translation output, and a transcript of another voice input corresponding to another voice. The other voice input, for example, can correspond to voice input that wasn't translated, but is provided in context with the translated voice input.

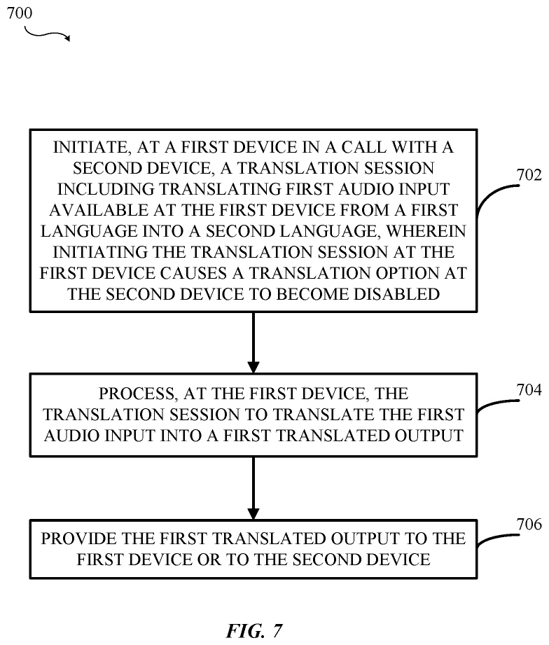

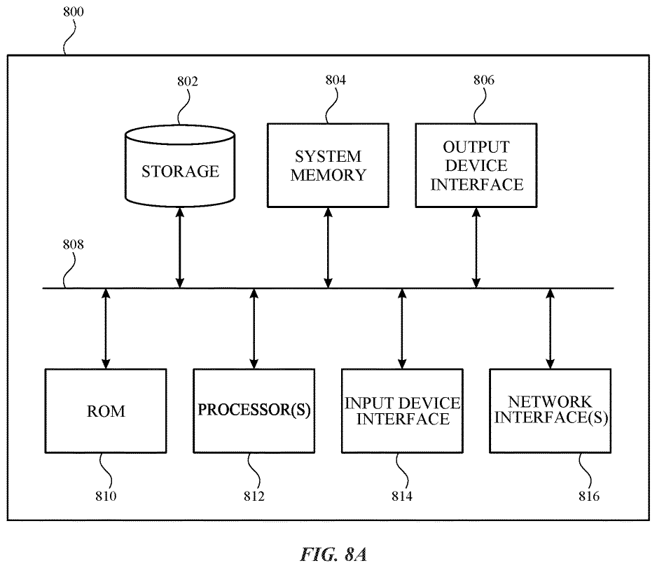

FIG. 7 illustrates a flow diagram of an example process 700 for providing a translation during a media session, in accordance with one or more implementations. For explanatory purposes, the process 700 is primarily described herein with reference to the components of FIG. 1 and FIG. 2 (particularly with reference to electronic device 200 (e.g., electronic device 110, electronic device 112, electronic device 114, and/or electronic device 116), which may be executed by one or more processors of the electronic device 200 of FIG. 2. However, the process 700 is not limited to the electronic device 200, and one or more blocks (or operations) of the process 700 may be performed by one or more other components of other suitable devices, such as one or more of the electronic devices 110, the electronic device 112, electronic device 114, and/or the electronic device 116. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

As shown in FIG. 7, process 700 at block 702 may include initiating, at a first device in a call with a second device, a translation session including translating first audio input available at the first device from a first language into a second language, where initiating the translation session at the first device causes a translation option at the second device to become disabled. When translation is occurring on one of the devices, a signal can be sent to a server, for example, the server 120, indicating that the translation is taking place. The server 120, can track which device is translating and which devices are involved in the call and provide to the other devices a signal indicating that they are disabled from translating any of the devices on the call. In other implementations, the server may not be used and a signal can be sent to each of the devices by the device translating to indicate that those devices should not also translate. It may be, for example, that when multiple devices are translating, then the synchronization of the audio inputs and translation outputs becomes onerous to manage. Each device may, for example, have unique network latency and allowing each device to translate may be detrimental to user experience. On the other hand, in some instances, each device can be configured to perform its own translating such that any input received from another device can be translated into another language at the first device. In such a scheme, the translating of the input spoken by the user of the first device would take place on the device that receives it. However, if the device is unable to provide translations, then the first device can provide the translation of the input spoken at the first device.

As also shown in FIG. 7, process 700 at block 704 may include processing, at the first device, the translation session to translate the first audio input into a first translated output. The first device can product the translated output from the audio input using a translation session that translates the audio input from a first language into a second language that is a preferred language for the first device or the second device.

As further shown in FIG. 7, process 700 at block 706 may include providing the first translated output to the first device or to the second device. The first translated output can be provided, for example, as a computer-generated voice speaking the first translated output and/or as a transcription of the translation. In some implementations, the first translated output may include both translated audio output and first translated transcript output. In some implementations, the first audio input is provided by the first device, and the first translated output is provided to the second device. In other words, the first audio input is translated at the first device for the benefit of the second device.

In one or more implementations, the translation session further includes translating a second audio input available at the first device and provided by the second device from a third language into a fourth language as second translated output, where the method further comprises: providing the second translated output to the first device, where the first translated output is provided to the second device. The first device can provide a translation of audio input at the first device to the second device and also provide a translation of audio input received at the second device and streamed to the first device from the second device.

In one or more implementations, in addition to a translation option being unavailable or disabled at other devices in the media session when the first device is translating, an option can be provided to request take over of the translation session. In such instances, the process 700 can further include receiving, at the first device, a request from the second device to take control of the translation session, and terminating the translation session at the first device, where the translation session is initiated at the second device. Thus, the second device can take over the translation process from the first device in this example.

As described herein, aspects of the subject technology may include the collection and transfer of data from an application to other users'computing devices. The present disclosure contemplates that in some instances, this collected data may include personal information data that uniquely identifies or can be used to identify a specific person. Such personal information data can include demographic data, location-based data, online identifiers, telephone numbers, email addresses, voice data, audio data, video data, home addresses, images, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used in providing a video conferencing session with a transcription. Further, other uses for personal information data that benefit the user are also contemplated by the present disclosure. For instance, health and fitness data may be used, in accordance with the user's preferences to provide insights into their general wellness, or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of video conferencing with transcription, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 8A illustrates an electronic system 800 with which one or more implementations of the subject technology may be implemented. The electronic system 800 can be, and/or can be a part of, the electronic device 110, the electronic device 112, the electronic device 114, the electronic device 116, the electronic device 118, the server 120, and/or the server 130 shown in FIG. 1. The electronic system 800 may include various types of computer readable media and interfaces for various other types of computer readable media. The electronic system 800 includes a bus 808, one or more processing unit(s) 812, a system memory 804 (and/or buffer), a ROM 810, a permanent storage device 802, an input device interface 814, an output device interface 806, and one or more network interfaces 816, or subsets and variations thereof.

The bus 808 collectively represents all system, peripheral, and chipset buses that communicatively connect the numerous internal devices of the electronic system 800. In one or more implementations, the bus 808 communicatively connects the one or more processing unit(s) 812 with the ROM 810, the system memory 804, and the permanent storage device 802. From these various memory units, the one or more processing unit(s) 812 retrieves instructions to execute and data to process in order to execute the processes of the subject disclosure. The one or more processing unit(s) 812 can be a single processor or a multi-core processor in different implementations.

The ROM 810 stores static data and instructions that are needed by the one or more processing unit(s) 812 and other modules of the electronic system 800. The permanent storage device 802, on the other hand, may be a read-and-write memory device. The permanent storage device 802 may be a non-volatile memory unit that stores instructions and data even when the electronic system 800 is off. In one or more implementations, a mass-storage device (such as a magnetic or optical disk and its corresponding disk drive) may be used as the permanent storage device 802.

In one or more implementations, a removable storage device (such as a floppy disk, flash drive, and its corresponding disk drive) may be used as the permanent storage device 802. Like the permanent storage device 802, the system memory 804 may be a read-and-write memory device. However, unlike the permanent storage device 802, the system memory 804 may be a volatile read-and-write memory, such as random access memory. The system memory 804 may store any of the instructions and data that one or more processing unit(s) 812 may need at runtime. In one or more implementations, the processes of the subject disclosure are stored in the system memory 804, the permanent storage device 802, and/or the ROM 810. From these various memory units, the one or more processing unit(s) 812 retrieves instructions to execute and data to process in order to execute the processes of one or more implementations.

The bus 808 also connects to the input and output device interfaces 814 and 806. The input device interface 814 enables a user to communicate information and select commands to the electronic system 800. Input devices that may be used with the input device interface 814 may include, for example, alphanumeric keyboards and pointing devices (also called “cursor control devices”). The output device interface 806 may enable, for example, the display of images generated by electronic system 800. Output devices that may be used with the output device interface 806 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 8A, the bus 808 also couples the electronic system 800 to one or more networks and/or to one or more network nodes, such as the network 106 shown in FIG. 1, through the one or more network interface(s) 816. In this manner, the electronic system 800 can be a part of a network of computers (such as a LAN, a wide area network (“WAN”), or an Intranet, or a network of networks, such as the Internet. Any or all components of the electronic system 800 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

Implementations within the scope of the present disclosure can be partially or entirely realized using a tangible computer-readable storage medium (or multiple tangible computer-readable storage media of one or more types) encoding one or more computer-executable instructions. It should be recognized that computer-executable instructions can be organized in any format, including applications, widgets, processes, software (e.g., one or more computer programs), and/or components.

Implementations within the scope of the present disclosure include a computer-readable storage medium that encodes instructions organized as an application (e.g., application 842) that, when executed by one or more processing units, control an electronic device (e.g., device 840) to perform the method of FIG. 8B, the method of FIG. 8C, and/or one or more other processes and/or methods described herein.

It should be recognized that application 842 (shown in FIG. 8D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 842 is an application that is pre-installed on device 840 at purchase (e.g., a first-party application). In some embodiments, application 842 is an application that is provided to device 840 via an operating system update file (e.g., a first-party application or a second-party application). In some embodiments, application 842 is an application that is provided via an application store. In some embodiments, the application store can be an application store that is pre-installed on device 840 at purchase (e.g., a first-party application store). In some embodiments, the application store is a third-party application store (e.g., an application store that is provided by another application store, downloaded via a communication network, and/or read from a storage device).

Referring to FIG. 8B, FIG. 8D, and FIG. 8F, application 842 obtains information (e.g., block 822). In some embodiments, at block 822, information is obtained from at least one hardware component of device 840. In some embodiments, at block 822, information is obtained from at least one software module of device 840. In some embodiments, at block 822, information is obtained from at least one hardware component external to device 840 (e.g., a peripheral device, an accessory device, and/or a server). In some embodiments, the information obtained at block 822 includes positional information, time information, notification information, user information, environment information, electronic device state information, weather information, media information, historical information, event information, hardware information, and/or motion information. In some embodiments, in response to and/or after obtaining the information at block 822, application 842 provides the information to a system (e.g., block 824).

In some embodiments, the system (e.g., 850 shown in FIG. 8E) to which information is provided is an operating system hosted on device 840. In some embodiments, the system (e.g., 850 shown in FIG. 8E) is an external device (e.g., a server, a peripheral device, an accessory, and/or a personal computing device) that includes an operating system that includes one or more system processes.

Referring to FIG. 8C and FIG. 8G, application 842 obtains information (e.g., block block 832). In some embodiments, the information obtained at block 832 includes positional information, time information, notification information, user information, environment information electronic device state information, weather information, media information, historical information, event information, hardware information, and/or motion information. In response to and/or after obtaining the information at block 832, application 842 performs an operation with the information (e.g., block 834). In some embodiments, the operation performed at block 834 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 850 based on the information.

In some embodiments, one or more steps of the method of FIG. 8B and/or the method of FIG. 8C is performed in response to a trigger. In some embodiments, the trigger includes detection of an event, a notification received from system 850, a user input, and/or a response to a call to an API provided by system 850.

In some embodiments, the instructions of application 842, when executed, control device 840 to perform the method of FIG. 8B and/or the method of FIG. 8C by calling an application programming interface (API) (e.g., API 852, FIG. 8E) provided by system 850. In some embodiments, application 842 performs at least a portion of the method of FIG. 8B and/or the method of FIG. 8C without calling API 852.

In some embodiments, one or more steps of the method of FIG. 8B and/or the method of FIG. 8C includes calling an API (e.g., API 852) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 8D, device 840 is illustrated. In some embodiments, device 840 is a personal computing device, a smart phone, a smart watch, a fitness tracker, a head mounted display (HMD) device, a media device, a communal device, a speaker, a television, and/or a tablet. The device 840 may be an instance of any of the devices described herein. As illustrated in FIG. 8D, device 840 includes application 842 and an operating system (e.g., system 850 shown in FIG. 8E). Application 842 includes application implementation module 844 and API-calling module 846. System 850 includes API 852 and implementation module 854. It should be recognized that device 840, application 842, and/or system 850 can include more, fewer, and/or different components than illustrated in FIGS. 8D and 8E.

In some embodiments, application implementation module 844 includes a set of one or more instructions corresponding to one or more operations performed by application 842. For example, when application 842 is a messaging application, application implementation module 844 can include operations to receive and send messages. In some embodiments, application implementation module 844 communicates with API-calling module 846 to communicate with system 850 via API 852 (shown in FIG. 8E).

In some embodiments, API 852 is a software module (e.g., a collection of computer-executable instructions) that provides an interface that allows a different module (e.g., API-calling module 846) to communicate with a system process to access and/or use one or more functions, methods, procedures, data structures, classes, and/or other services provided by implementation module 854 of system 850. For example, API-calling module 846 can access a feature of implementation module 854 through one or more API calls or invocations (e.g., embodied by a function or a method call) exposed by API 852 (e.g., a software and/or hardware module that can receive API calls, respond to API calls, and/or send API calls) and can pass data and/or control information using one or more parameters via the API calls or invocations. In some embodiments, API 852 allows application 842 to use a service provided by a Software Development Kit (SDK) library. In some embodiments, application 842 incorporates a call to a function or method accessed using the SDK library and provided by API 852 or uses data types or objects defined in the SDK library and provided by (or accessed using) API 852. In some embodiments, API-calling module 846 makes an API call via API 852 to access and use a feature of implementation module 854 that is specified by API 852. In such embodiments, implementation module 854 can return a value via API 852 to API-calling module 846 in response to the API call. The value can report to application 842 the capabilities or state of a hardware component of device 840, including those related to aspects such as input capabilities and state, output capabilities and state, processing capability, power state, storage capacity and state, and/or communications capability. In some embodiments, API 852 is implemented in part by firmware, microcode, or other low level logic that executes in part on the hardware component of device 840.

In some embodiments, API 852 allows a developer of API-calling module 846 (which can be a third-party developer) to leverage a feature provided by implementation module 854. In such embodiments, there can be one or more API calling modules (e.g., including API-calling module 846) that communicate with implementation module 854. In some embodiments, API 852 allows multiple API calling modules written in different programming languages to communicate with implementation module 854 (e.g., API 852 can include features for translating calls and returns between implementation module 854 and API-calling module 846) while API 852 is implemented in terms of a specific programming language. In some embodiments, API-calling module 846 calls APIs from different providers such as a set of APIs from an OS provider, another set of APIs from a plug-in provider, and/or another set of APIs from another provider (e.g., the provider of a software library) or creator of the another set of APIs.

Examples of API 852 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 840. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 854 is a system (e.g., operating system and/or server system) software module (e.g., a collection of computer-executable instructions) that is constructed to perform an operation in response to receiving an API call via API 852. In some embodiments, implementation module 854 is constructed to provide an API response (via API 852) as a result of processing an API call. By way of example, implementation module 854 and API-calling module 846 can each be any one of an operating system, a library, a device driver, an API, an application program, or other module. It should be understood that implementation module 854 and API-calling module 846 can be the same or different type of module from each other. In some embodiments, implementation module 854 is embodied at least in part in firmware, microcode, or hardware logic.

In some embodiments, implementation module 854 returns a value through API 852 in response to an API call from API-calling module 846. While API 852 defines the syntax and result of an API call (e.g., how to invoke the API call and what the API call does), API 852 might not reveal how implementation module 854 accomplishes the function specified by the API call. Various API calls are transferred via the one or more application programming interfaces between API-calling module 846 and implementation module 854. Transferring the API calls can include issuing, initiating, invoking, calling, receiving, returning, and/or responding to the function calls or messages. In other words, transferring can describe actions by either of API-calling module 846 or implementation module 854. In some embodiments, a function call or other invocation of API 852 sends and/or receives one or more parameters through a parameter list or other structure of API 852.

In some embodiments, implementation module 854 provides more than one API, each providing a different view of or with different aspects of functionality implemented by implementation module 854. For example, one API of implementation module 854 can provide a first set of functions and can be exposed to third-party developers, and another API of implementation module 854 can be hidden (e.g., not exposed) and provide a subset of the first set of functions and also provide the first set of functions, or another set of functions, such as testing or debugging functions which are not in the first set of functions. In some embodiments, implementation module 854 calls one or more other components via an underlying API and thus is both an API calling module and an implementation module. It should be recognized that implementation module 854 can include additional functions, methods, classes, data structures, and/or other features that are not specified through API 852 and are not available to API-calling module 846. It should also be recognized that API-calling module 846 can be on the same system as implementation module 854 or can be located remotely and access implementation module 854 using API 852 over a communication network. In some embodiments, implementation module 854, API 852, and/or API-calling module 846 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected, the direct sensor data (e.g., data representing or corresponding to detection of the input) is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls made between steps of interacting with the computer system (e.g., API calls between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform process 600 (e.g., as discussed herein with respect to FIGS. 8A-8E) by calling an application programming interface (API) provided by the system process using one or more parameters.

In some embodiments, example APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-executable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 852 defines a first API call that can be provided by API-calling module 846. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 840) that runs the application. In some embodiments, the implementation module is included in an electronic device that is separate from the device that runs the application.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the above-described translation processes can be used to benefit users. For example, the data can be used to train models that can be deployed to improve performance, accuracy, and/or functionality of applications and/or services. Accordingly, the use of the data enables the above-described translation processes to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the above-described translation processes are also contemplated by the present disclosure.

The present disclosure contemplates that, in some embodiments, data used by above-described translation processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with above-described translation processes, should attempt to comply with well-established privacy policies and/or privacy practices.

For example, such entities may implement and consistently follow policies and practices recognized as meeting or exceeding industry standards and regulatory requirements for developing and/or training above-described translation processes. In doing so, attempts should be made to ensure all intellectual property rights and privacy considerations are maintained. Training should include practices safeguarding training data, such as personal information, through sufficient protections against misuse or exploitation. Such policies and practices should cover all stages of the above-described translation processes development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, above-described translation processes may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for above-described translation processes may be kept strictly separated from platforms where the above-described translation processes are deployed and/or used to interact with users and/or process data. In such embodiments, data used for offline training of the above-described translation processes may be maintained in secured datastores with restricted access and/or not be retained beyond the duration necessary for training purposes. In some embodiments, the above-described translation processes may utilize a local memory cache to store data temporarily during a user session. The local memory cache may be used to improve performance of the above-described translation processes. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the above-described translation processes. The above-described translation processes should be monitored for changes in underlying data distribution such as concept drift or data skew that can degrade performance of the above-described translation processes over time.

In some embodiments, the above-described translation processes are trained using a combination of offline and online training. Offline training can use curated datasets to establish baseline model performance, while online training can allow the above-described translation processes to continually adapt and/or improve. The present disclosure recognizes the importance of maintaining strict data governance practices throughout this process to ensure user privacy is protected.

In some embodiments, the above-described translation processes may be designed with safeguards to maintain adherence to originally intended purposes, even as the above-described translation processes adapt based on new data. Any significant changes in data collection and/or applications of above-described translation process use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the above-described translation processes and/or for use as input during the inference stage of such systems. In yet another example, the present technology should be configured to allow users to be able to select to limit the length of time data is maintained or entirely prohibit the use of their data for use by the above-described translation processes. In addition to providing “opt in” and “opt out” options, the present disclosure contemplates providing notifications relating to the access or use of personal information. For instance, a user can be notified when their data is being input into the above-described translation processes for training or inference purposes, and/or reminded when the above-described translation processes generate outputs or make decisions based on their data.

The present disclosure recognizes the above-described translation processes should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to or failures to cite third-party products and/or services in the outputs should not be construed as endorsements or affiliations by the entities providing the above-described translation processes. Generated content can be filtered for potentially inappropriate or dangerous material prior to being presented to users, while human oversight and/or ability to override or correct erroneous or undesirable outputs can be maintained as a failsafe.

The present disclosure further contemplates that users of the above-described translation processes should refrain from using the services in any manner that infringes upon, misappropriates, or violates the rights of any party. Furthermore, the above-described translation processes should not be used for any unlawful or illegal activity, nor to develop any application or use case that would commit or facilitate the commission of a crime, or other tortious, unlawful, or illegal act including misinformation, disinformation, misrepresentations (e.g., deepfakes), deception, impersonation, and propaganda. The above-described translation processes should not violate, misappropriate, or infringe any copyrights, trademarks, rights of privacy and publicity, trade secrets, patents, or other proprietary or legal rights of any party, and appropriately attribute content as required. Further, the above-described translation processes should not interfere with any security, digital signing, digital rights management, content protection, verification, or authentication mechanisms. The above-described translation processes should not misrepresent machine-generated outputs as being human-generated.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the phrase “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
in response to a user request for language translation at a first device, initiating a language translation session corresponding to a voice or video call with a second device, wherein the language translation session comprises a translation process to translate a first audio capture containing first speech received at the first device from a first language into a second language;
in response to the initiating the language translation session, translating, at the first device, the first audio capture comprising the first language to a translated output comprising the second language; and
providing the translated output to the first device or the second device.

2. The method of claim 1, wherein the user request corresponds to a selection provided by a user of the first device to an input element displayed at the first device to begin the translation process during the voice or video call.

3. The method of claim 1, further comprising:
detecting the first language from the first audio capture; and
in response to the detection of the first language, providing a prompt on the first device to initiate the language translation, wherein the user request is received via the prompt.

4. The method of claim 3, wherein the first language is different from a preferred language preset on the first device wherein the second language corresponds to the preferred language preset.

5. The method of claim 1, further comprising:
determining that the second device is associated with a geographic region associated with the second language, based at least in part on an area code or contact location information associated with the second device; and
in response to the determination that the second device is associated with the geographic region associated with the second language, providing a prompt on the first device to initiate the language translation, wherein the user request is received via the prompt.

6. The method of claim 5, wherein providing the prompt occurs before the voice or video call is established.

7. The method of claim 1, further comprising:
receiving a request at the first device from the second device to provide a language translation; and
in response to receiving the request to provide the language translation, providing a prompt on the first device to initiate the language translation, wherein the user request is received via the prompt.

8. The method of claim 7, wherein the request is received as a sequence of one or more numeric telephone key tones.

9. The method of claim 1, wherein the first audio capture is provided by a user of the first device and captured by a microphone of the first device, and wherein the first audio capture and the translated output is provided to the second device from the first device.

10. The method of claim 1, wherein the first audio capture is provided by a user of the second device and captured by a microphone of the second device and transferred to the first device, wherein the first audio capture and the translated output is output by a speaker of the first device.

11. A non-transitory computer-readable medium storing instructions that, when executed by one or more processors of a first device, cause the one or more processors to:
receive a request to translate a first audio capture originating from the first device or from a second device from a first language into a second language;
provide, to the second device, a request to output an indication that the first audio capture will be translated from the first language;
following a pre-determined period, translate, by a language model, the first audio capture from the first language into an output file comprising a representation of the audio capture in the second language; and
provide the output file to the first device or to the second device.

12. The non-transitory computer-readable medium of claim 11, wherein the indication corresponds to a computer-generated announcement played on the second device.

13. The non-transitory computer-readable medium of claim 11, the instructions further causing the one or more processors to:
provide, at the first device, an indication that the first audio capture will be translated from the first language into the second language.

14. The non-transitory computer-readable medium of claim 11, wherein the output file corresponds to an audio file, and wherein the audio file comprises a computer-generated voice.

15. The non-transitory computer-readable medium of claim 11, wherein the output file corresponds to a text transcript.

16. The non-transitory computer-readable medium of claim 15, wherein the text transcript is read by a computer-generated voice and output over a speaker.

17. The non-transitory computer-readable medium of claim 11, wherein the first device and the second device are participating in a video or telephone call.

18. A non-transitory computer-readable medium storing instructions that, when executed by one or more processors of a first device, cause the one or more processors to:
output, at the first device participating in a multimedia session with a second device, a translation output of voice input received by a microphone of the first device or by a microphone of the second device,
wherein the translation output is produced in real-time by the first device or by the second device,
wherein the voice input is received in a first language, and
wherein the translation output of the voice input is provided in a second language different from the first language.

19. The non-transitory computer-readable medium of claim 18, the instructions further causing the one or more processors to:
receive the voice input at the first device; and
transfer an audio stream to the second device including a representation of the voice input, wherein the translation output is produced by the second device.

20. The non-transitory computer-readable medium of claim 18, the instructions further causing the one or more processors to:
translate, by the first device, the voice input into the translation output.

21. The non-transitory computer-readable medium of claim 20, wherein the voice input is received at the second device and streamed to the first device over a network.

22. The non-transitory computer-readable medium of claim 20, the instructions further causing the one or more processors to:
output, at the first device, a first output corresponding to the voice input at a first volume level; and
output, at the first device, the translation output at a second volume level greater than the first volume level.

23. The non-transitory computer-readable medium of claim 18, wherein the translation output is provided in a computer-generated voice based on a user-selected style.

24. The non-transitory computer-readable medium of claim 18, the instructions further causing the one or more processors to:
receive, at the first device, a user input indicating a selection of a transcript; and
stream a real-time transcript of the translation output to the first device.

25. The non-transitory computer-readable medium of claim 24, wherein the real-time transcript is provided by the second device.

26. The non-transitory computer-readable medium of claim 24, wherein the real-time transcript includes a transcript of the voice input and the translation output.

27. The non-transitory computer-readable medium of claim 18, the instructions further causing the one or more processors to:
terminate the multimedia session;
provide a prompt via a user interface of the first device to obtain a transcript of the multimedia session; and
obtain the transcript of the multimedia session, wherein the transcript includes a transcript of the voice input, a transcript of the translation output, and a transcript of another voice input corresponding to another voice.

28. A method comprising:
initiating, at a first device in a call with a second device, a translation session including translating first audio input available at the first device from a first language into a second language, wherein initiating the translation session at the first device causes a translation option at the second device to become disabled;
processing, at the first device, the translation session to translate the first audio input into a first translated output; and
providing the first translated output to the first device or to the second device.

29. The method of claim 28, where the first translated output comprises first translated audio output and first translated transcript output.

30. The method of claim 28, wherein the first audio input is provided by the first device, wherein the first translated output is provided to the second device.

31. The method of claim 30, wherein the translation session further includes translating a second audio input available at the first device and provided by the second device from a third language into a fourth language as second translated output, wherein the method further comprises:
providing the second translated output to the first device, wherein the first translated output is provided to the second device.

32. The method of claim 28, further comprising:
receiving, at the first device, a request from the second device to take control of the translation session; and
terminating the translation session at the first device, wherein the translation session is initiated at the second device.
